(19) United States
(12) Patent Application Publication
(10) Pub. No.: US 2026/0152999 A1
(43) Pub. Date: Jun. 4, 2026

(54) ROLLING SHUTTER EGRESS SYSTEM

(71) Applicant: Qualitas Manufacturing Incorporated, Itasca, IL (US)

(72) Inventors: Johanna Slobidsky, Downers Grove, IL (US); Tyler Czerwinski, Aurora, IL (US); Craig Zarbeck, Stevensville, IL (US)

(21) Appl. No.: 19/408,018

(22) Filed: Dec. 3, 2025

Related U.S. Application Data
(60) Provisional application No. 63/727,759, filed on Dec. 4, 2024.

(51) Int. Cl. E06B 9/80; E06B 9/60; E06B 9/72; E06B 9/74

(52) U.S. Cl. CPC E06B 9/80; E06B 9/60; E06B 9/74; E06B 2009/725; E06B 2009/802

(57) ABSTRACT

An egress system for a motorized rolling shutter, comprises an articulated shutter curtain that is raised or lowered by winding or unwinding the curtain about a rotatable cylinder. A planetary gear system comprises a sun gear, planet gears, a planet carrier, and a ring gear. Rotation of the planet carrier is driven by a motor, and ring gear is rotationally coupled to the cylinder. In motorized operation, the rotation of the sun gear is arrested by a brake, such that the rotation of the planet carrier causes the planet gears to rotate, which drive the rotation of the ring gear and cylinder. When the motor is inoperable, the brake is released to permit rotation of the sun gear, which permits the planet gears to rotate without rotation of the planet carrier, and allows the manual rotation of the ring gear and cylinder.

### CROSS-REFERENCE TO RELATED APPLICATIONS

This application claims the benefit of U.S. Provisional Application No. 63/727,759, filed on Dec. 4, 2024, which is incorporated herein by reference in its entirety.

### BACKGROUND OF THE INVENTION

The present invention relates to motorized rolling shutters and, in particular, to motorized rolling shutters with emergency egress systems for manual operation of the rolling shutter.

Rolling shutters are commonly used in doorways, windows, and other structural openings, for privacy, security, and protection from the environment such as extreme weather. The shutters are typically constructed of multiple slats that are hingedly linked to form an articulated curtain. When not in use, the curtain is raised from the opening and wound about cylinder or barrel that is concealed within a housing or box above the doorway or other opening. Examples of rolling shutters are disclosed in U.S. Pat. No. 9,074,411 to Miller et al., which is incorporated herein by reference.

Rolling shutters can be heavy and difficult to manually raise and lower, and are often motorized for convenience and speed of operation. However, if the motor cannot be operated (e.g. during a power outage) or otherwise malfunctions, the rolling shutter may also become inoperable. These circumstances can create a hazard where the rolling shutter becomes fixed in the closed position and prevents exit during an emergency. Accordingly, building codes and regulations typically require power operated or assisted doors to be capable of manual (non-motorized) opening or closing during a power outage. Therefore, it would be desirable to provide a system for manual override of a motorized rolling shutter, to allow for emergency egress in situations where the motor becomes inoperable. The emergency egress system preferably fits within a standard rolling shutter housing, and requires only a simple action and operation by a single user.

### SUMMARY OF THE INVENTION

An egress system for a motorized rolling shutter is disclosed, that comprises a rotatable hollow cylinder having an interior space, a planetary gear system, a motor, and a brake. The planetary gear system is positioned in the cylinder interior space, and comprises a rotatable sun gear; a rotatable planet gear in meshing engagement with the sun gear; a rotatable carrier, the planet gear rotatably coupled to the carrier, and a ring gear rotationally coupled to the cylinder. The planet gear is in meshing engagement with the ring gear and positioned between the ring gear and sun gear. The motor is coupled to the carrier, and has an on state which drives the rotation of the carrier, and an off state that arrests the rotation of the carrier. The brake is coupled to the sun gear, and is reversibly actuated to arrest rotation of the sun gear or released to permit rotation of the sun gear. The motor in the off state and the brake released, permits rotation of the planet gear on the arrested carrier, and allows rotation of the ring gear and the coupled cylinder.

In another embodiment, an egress system for a motorized rolling shutter comprises a rotatable hollow cylinder having an interior space, a planetary gear system, a motor, a detent brake, and a torsion spring. The planetary gear system is positioned in the cylinder interior space, and comprises a rotatable sun gear, a rotatable planet gear in meshing engagement with the sun gear, a rotatable carrier, the planet gear rotatably coupled to the carrier, and a ring gear rotationally coupled to the cylinder. The planet gear is in meshing engagement with the ring gear and is positioned between the ring gear and sun gear. The motor is positioned in the cylinder interior space and is coupled to the carrier. The motor has an on state that drives the rotation of the carrier, and an off state that arrests the rotation of the carrier. The detent brake is coupled to the sun gear, and comprises a locking arm with a lock pin, and a detent wheel rotationally coupled to the sun gear. The detent wheel has a notch that is sized and shaped to receive the lock pin. The detent brake is moveable between an actuated position with the lock pin received in the detent wheel notch to arrest the rotation of the detent wheel and coupled sun gear, and a released position with the lock pin removed from the detent wheel notch to permit rotation of the ratchet wheel and coupled sun gear. The torsion spring is coupled to and exerts a rotational force on the cylinder. The detent brake in the released position permits the rotation of the planet gear on the arrested carrier, and permits rotation of the ring gear and coupled cylinder with the motor in the off state.

In another embodiment, an egress system for a motorized rolling shutter comprises a rotatable hollow cylinder having an interior space, an articulated curtain, a planetary gear system, a motor, and a brake. The articulated curtain is coupled to the cylinder, and is moveable between a raised position wound about the cylinder, and a lowered position unwound from the cylinder. The planetary gear system is positioned in the cylinder interior space, and comprises a rotatable sun gear, a rotatable planet gear in meshing engagement with the sun gear, a rotatable carrier, the planet gear rotatably coupled to the carrier, and a ring gear rotationally coupled to the cylinder. The planet gear is in meshing engagement with the ring gear and positioned between the ring gear and sun gear. The motor is coupled to the carrier, and has an on state which drives the rotation of the carrier and the movement of the curtain, and an off state that arrests the rotation of the carrier and the movement of the curtain. The brake is coupled to the sun gear, and is reversibly actuated to arrest rotation of the sun gear or released to permit rotation of the sun gear. The brake released permits rotation of the planet gear on the arrested carrier, which allows rotation of the ring gear and the coupled cylinder, and allows the movement of the curtain with the motor in the off state.

### BRIEF DESCRIPTION OF THE DRAWINGS

FIG. 1 is a cutaway, isometric view of a motorized rolling shutter in a housing including a manual egress system.

FIG. 2 is a top section view of the motorized rolling shutter of FIG. 1.

FIG. 3 is a cutaway, isometric view of the planetary gear system of the motorized rolling shutter of FIG. 1.

FIG. 4 is an isometric view of the drum brake of the motorized rolling shutter of FIG. 1.

FIG. 5 is an isometric view of a disc brake of a manual egress system for a motorized rolling shutter.

FIG. 6 is a cutaway, isometric view of a detent brake of a manual egress system for a motorized rolling shutter.

### DETAILED DESCRIPTION OF THE INVENTION

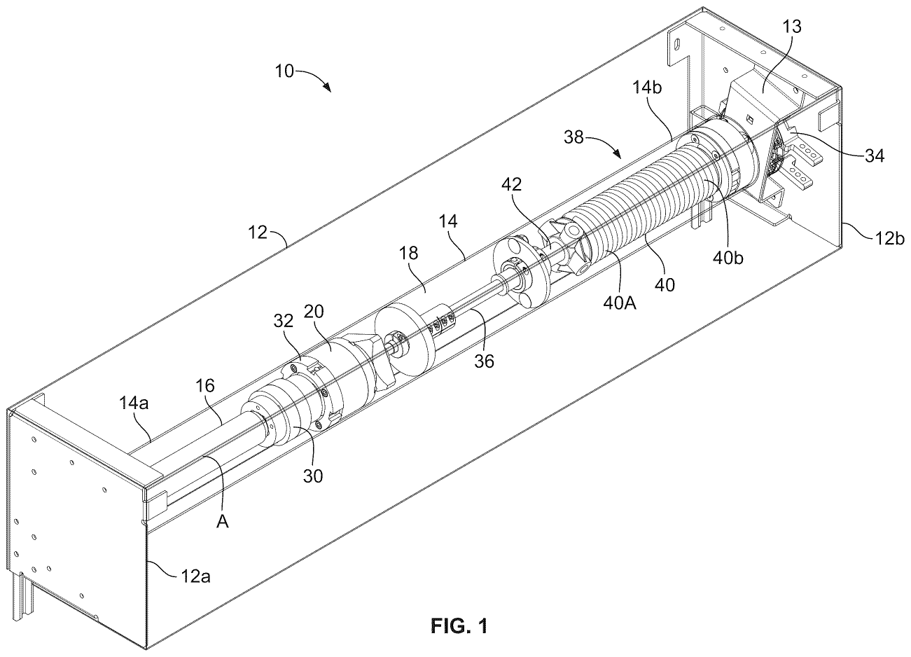

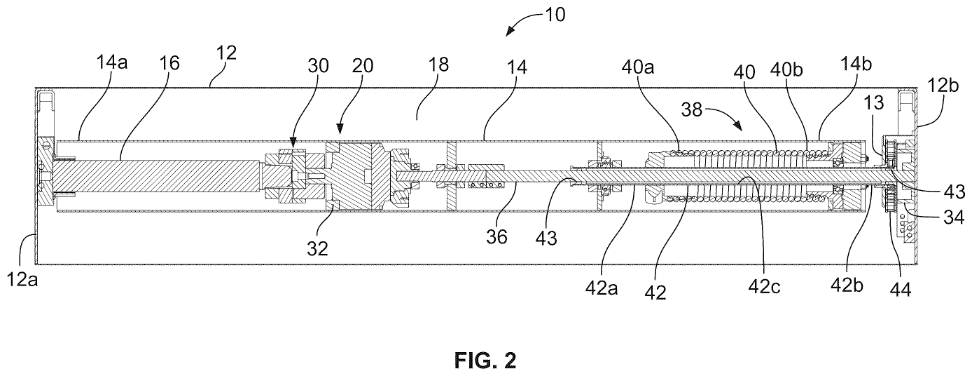

Referring to FIGS. 1 and 2, an embodiment of an egress system for a motorized rolling shutter 10 is shown. Rolling shutter 10 may be installed in a doorway, window, or other structural opening, and comprises a casing or housing 12 that is positioned at the opening (e.g., above a doorway). Housing 12 has opposite ends with end caps 12a and 12b. A hollow drive cylinder 14 is mounted in housing 12, and rotatable about its longitudinal axis A. Drive cylinder 14 is coupled to a conventional articulated shutter curtain (not shown) formed of multiple hingedly linked shutter slats. The shutter curtain is moveable between raised and lowered positions by rotating drive cylinder 14 to wind the shutter curtain about the drive cylinder and raise the curtain from the opening, or to unwind and lower the curtain to close the opening. Examples of rolling shutters are described in U.S. Pat. No. 8,944,137 to Miller and U.S. Pat. No. 10,465,440 to Miller et al., each of which is incorporated herein by reference.

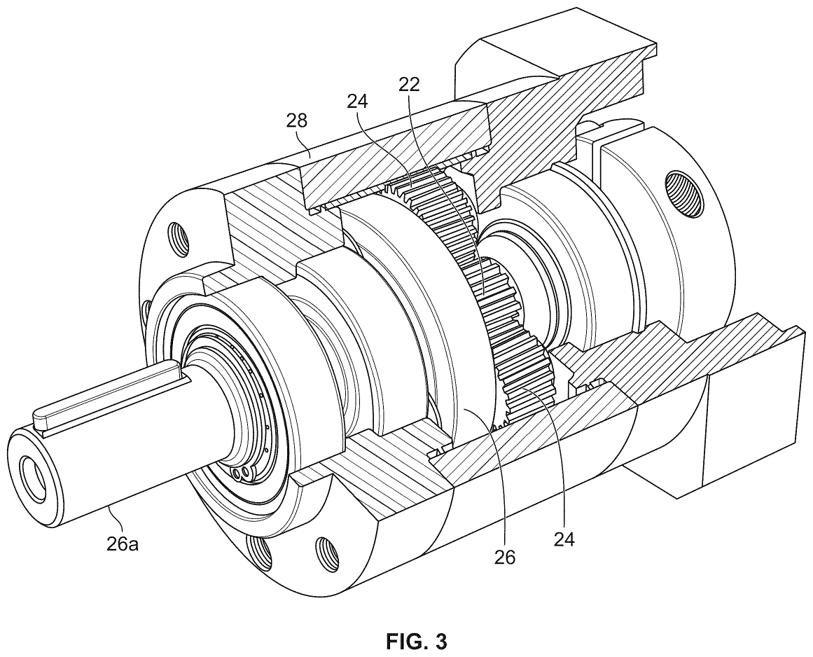

The rotation of drive cylinder 14 is driven by a motor 16, that is coupled to an epicyclic or planetary gear system 20. In the embodiment of FIG. 3, planetary gear system 20 is coupled to drive cylinder 14, and comprises rotatable central sun gear 22, planet gears 24, planet carrier 26, and outer ring gear 28. In one embodiment, motor 16 is coupled to planetary gear system 20 by a planetary adapter 30. In another embodiment, ring gear 28 is coupled to drive cylinder 14 by a cylinder adapter 32. Motor 16 and/or planetary gear system 20 may be external to drive cylinder 14, but are preferably positioned in cylinder interior space 18 to minimize the volume required by the rolling shutter 10. For example, motor 16 may be a bidirectional tubular motor that is sized to fit in drive cylinder interior space 18. In the embodiment of FIG. 2, tubular motor 16 is positioned in cylinder interior space 18 at cylinder end 14a, and is mounted on housing end cap 12a coaxially with cylinder longitudinal axis A.

Planetary gear system 20 may have a conventional configuration, with a sun gear 22, a planet carrier 26, and a ring gear 28 that have coaxial axes of rotation. Ring gear is coupled to and rotates with drive cylinder 14 (e.g., by a cylinder adapter 32). In one embodiment, sun gear 22, planet carrier 26, and ring gear 28 are coaxial with longitudinal axis of rotation A of drive cylinder 14. The operation of planetary gear system 20 drives the rotation of drive cylinder 14 to raise or lower (wind or unwind) the shutter curtain. Conversely, the manual rotation of drive cylinder 14 (e.g., non-motorized raising or lowering the shutter curtain), operates planetary gear system 20.

Planet gears 24 are rotatably coupled to planet carrier 26, and are positioned between and in meshing engagement with central sun gear 22 and outer ring gear 28. In one embodiment, planet carrier 26 has a shaft 26a extending along the axis of rotation, opposite planet gears 24. Motor 16 is coupled to and rotates carrier shaft 26a to drive the rotation of planet carrier 26. Carrier shaft 26a may be directly coupled to the output shaft of motor 16. In a preferred embodiment, planetary adapter 30 is a flexible shaft coupling between carrier shaft 26a and the output shaft of motor 16, that allows some degree of misalignment between the shafts and provides manufacturing tolerance. Flexible shaft couplings are known in the art, and include Lovejoy couplings that are commercially available (e.g., McMaster-Carr-Elmhurst, Illinois).

Sun gear 22 is coupled to a brake 34 that is reversibly actuated to arrest rotation of the sun gear, or released to permit the rotation of the sun gear. In one embodiment, sun gear 22 is coupled to brake 34 by a brake shaft 36 that is coupled to and rotates with the sun gear. In the embodiment of FIGS. 1 and 2, brake shaft 36 is a cylinder that extends between planetary gear system 20 and brake 34.

In a preferred embodiment, motor 16, planetary gear system 20, brake shaft 36, and brake 34 are all coaxial with longitudinal axis of rotation A of drive cylinder 14. In the embodiment of FIGS. 1 and 2, brake 34 and motor 16 are respectively positioned at opposite ends 14b and 14a of drive cylinder 14. Motor 16 is positioned within interior space 18 at cylinder end 14a, planetary gear system 20 is positioned proximal to the motor, and brake 34 is positioned at opposite cylinder end 14b.

In normal operation, bidirectional motor 16 is operable to rotate drive cylinder 14 to wind or unwind the shutter curtain about the cylinder, and move the shutter curtain between a raised or lowered position. When motor 16 is turned on, the motor 16 drives the rotation of planet carrier 26, which drives planet gears 24 to revolve about central sun gear 22. Brake 34 is actuated by default to arrest the rotation of sun gear 22, such that the revolution of planet gears 24 about the fixed sun gear drives the rotation of the planet gears on planet carrier 26. The rotation of planet gears 24 drives the rotation of outer ring gear 28, which rotates the coupled drive cylinder 14 to wind or unwind the shutter curtain about the cylinder and raise or lower the curtain.

When motor 16 is turned off or inoperable, the rotation of planet carrier 26 is arrested. Planet gears 24 cannot revolve about sun gear 22, and the fixed sun gear prevents the planet gears from rotating on planet carrier 26. Because planet gears 24 are fixed, drive cylinder 14 cannot rotate freely to allow the shutter curtain to be manually raised or lowered (wound or unwound).

To allow emergency operation of rolling shutter 10 when motor 16 is inoperable, brake 34 may be released to permit rotation of brake shaft 36 and coupled sun gear 22. Free rotation of sun gear 22 permits planet gears 24 to rotate on planet carrier 26 (without revolving about the sun gear), and allows the free rotation of drive cylinder 14 for manual operation of the shutter (i.e. operation independent of motor 16).

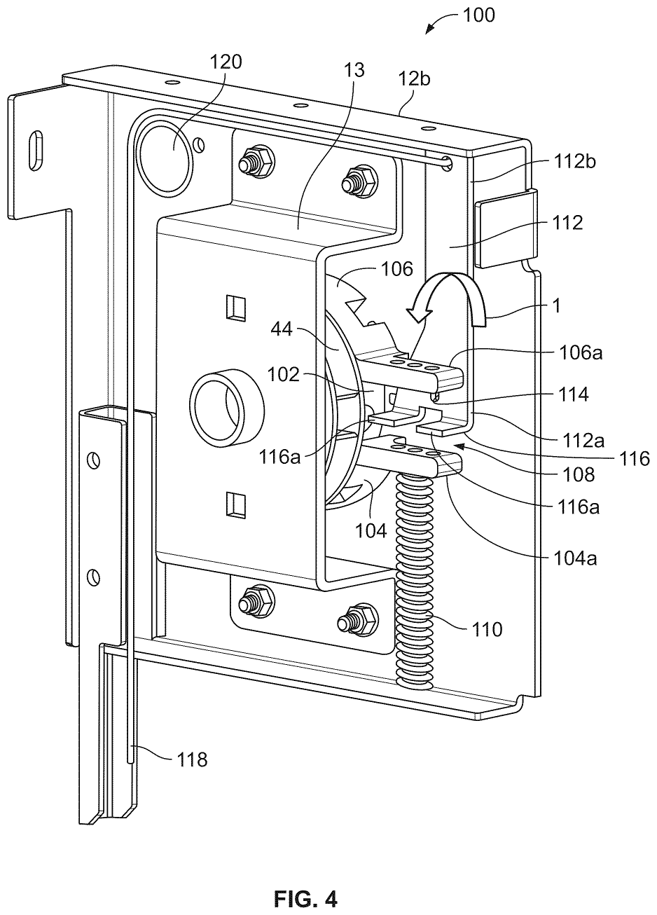

Brake 34 may be a friction brake system, such as a drum brake or disc brake. FIG. 4 shows an embodiment of a drum brake or clasp brake system 100 that is mounted on housing end cap 12b opposite motor 16. Brake system 100 comprises a cylindrical brake drum 102 that is coupled to and rotates with brake shaft 36 and sun gear 22. Brake shoes 104 and 106 are positioned on either side of brake drum 102, and respectively have flanges 104a and 106a that project away from the brake drum and are spaced apart by a gap 108. Brake system 100 is actuated by forcing brake shoes 104 and 106 together to contact and frictionally arrest the rotation of brake drum 102, and the coupled brake shaft 36 and sun gear 22. In one embodiment, brake system 100 is actuated by default. A spring 110 exerts pressure on brake shoe flange 104a to urge brake shoes 104 and 106 together, which contact and arrest the rotation of brake drum 102.

Brake system 100 is released by a release lever 112 that pivots or rotates on a pin 114. Lever 112 has an end 112a positioned at the gap 108 between brake shoe flanges 104a and 106a, and an opposite end 112b that extends away from brake shoes 104 and 106, and brake drum 102. A cam 116 is formed at lever end 112a, and is positioned in gap 108 between brake shoe flanges 104a and 106a. The rotation of lever 112 (arrow B) actuates cam 116 to force apart brake shoe flanges 104a and 106a against the pressure of spring 110. In one embodiment, cam 116 comprises one or more cam flanges 116a that project between brake shoe flanges 104a and 106a. As lever pivots on pin 114, cam flanges 116a rotate into contact with brake shoe flanges 104a and/or 106a, and force apart the brake shoe flanges and increase the spacing of gap 108. As brake shoe flanges 104a and 106a move away from each other, brake shoes 104 and 106 move away from engagement with brake drum 102 to release and permit the free rotation of the brake drum, and coupled brake shaft 36 and sun gear 22.

The rotation of lever 112 may be actuated by a brake cable 118. In the embodiment of FIG. 4, cable 118 is coupled to lever end 112b. Pulling or applying tension on cable 118 causes lever 112 to pivot on pin 114 and actuate cam 116 to release brake system 100. Releasing tension on cable 118 releases cam 116, and permits spring 110 to urge brake shoes 104 and 106 together to arrest the rotation of brake drum 102. Cable 118 may be coupled to one or more wheels or pulleys 120, to redirect the cable and facilitate the application of torque on lever 112.

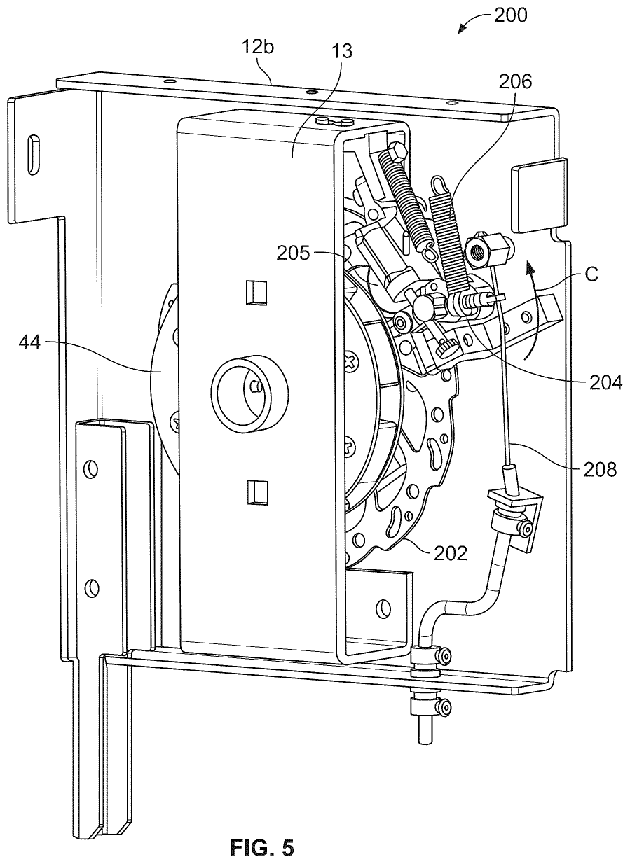

FIG. 5 shows an alternative embodiment of a disc brake system 200, comprising a brake rotor 202 that is coupled to and rotates with brake shaft 36 and sun gear 22. A rotatable lever 204 is coupled to a conventional brake caliper 205 with caliper arms (not shown) positioned on either side of brake rotor 202. Brake system 200 is actuated by rotation of lever 204 (arrow C), which forces the caliper arms together to contact and frictionally arrest the rotation of brake rotor 202, and the coupled brake shaft 36 and sun gear 22. Brake caliper 205 may be mechanically operated, but is preferably hydraulic for improved clamping force.

In one embodiment, brake system is actuated by default. A spring 206 urges lever 204 to rotate and force the caliper arms to engage and arrest the rotation of brake rotor 202. Brake system 200 is released by rotating lever 204 in the opposite direction of arrow C, against the pressure of spring 206, to permit the caliper arms to move away from and release brake rotor 202, which allows the free rotation of the brake rotor, and coupled brake shaft 36 and sun gear 22.

The rotation of lever 204 to release brake system 200 may be actuated by a brake cable 208. In the embodiment of FIG. 5, cable 208 is coupled to lever 204. Pulling or applying tension on cable 208 causes lever 204 to rotate against the pressure of spring 206, and release brake system 200. Releasing tension on cable 208 permits spring 206 to urge the rotation of lever 204 in the direction of arrow C, to force the caliper arms together and arrest the rotation of brake rotor 202.

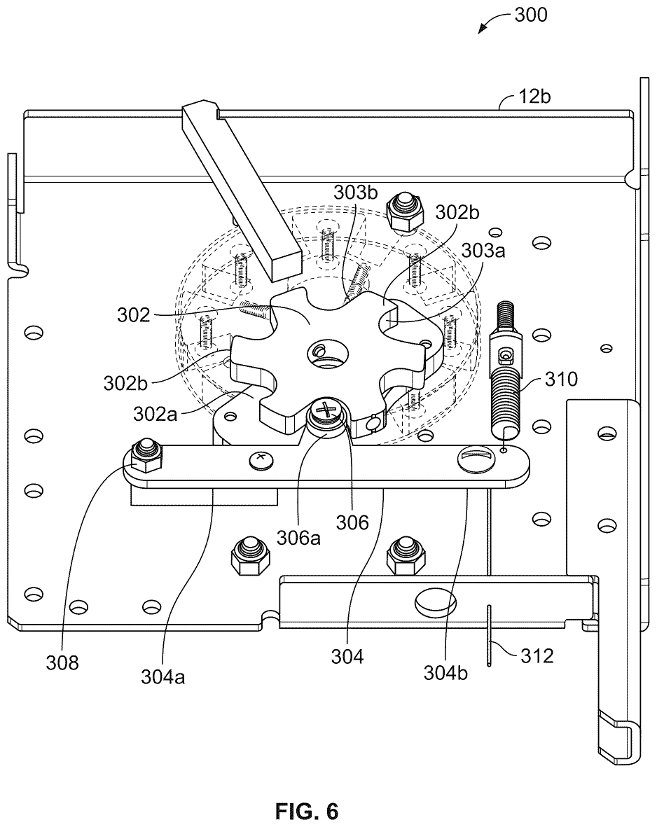

Friction brake systems can be susceptible to wear from use, and may require adjustment or replacement of parts over time. For example, brake shoes and caliper arms may become worn over time, which may reduce the effectiveness of brake systems 100 and 200. In a preferred embodiment, brake 34 is a detent brake system that provides a positive lock or stop to the rotation of sun gear 22. FIG. 6 shows an embodiment of a detent brake system 300, that comprises a detent wheel 302, a locking arm 304, and a lock pin 306 positioned on the locking arm. Detent wheel 302 is coupled to and rotates with brake shaft 36 and sun gear 22. One or more notches 302a are formed in the perimeter of detent wheel 302, that are sized and shaped to receive lock pin 306.

Locking arm 304 is moveable to reversibly engage pin 306 with a notch 302a. In one embodiment, locking arm 304 has opposite ends 304a and 304b, with lock pin 306 positioned between ends 304a and 304b. Locking arm end 304a is rotatably coupled to a pivot 308, to allow detent arm 304 to rotate toward or away from detent wheel 302. As locking arm 304 rotates toward detent wheel 302, lock pin 306 is positioned on the locking arm to be received in and engage a notch 302a. The engagement of lock pin 306 in notch 302a prevents the rotation of detent wheel 302, and coupled brake shaft 36 and sun gear 22.

In one embodiment, brake system 300 is actuated by default. A spring 310 is coupled to locking arm 304, that biases the locking arm to rotate toward detent wheel 302 and lock pin 306 toward engagement with a notch 302a, and stop the rotation of the detent wheel, and coupled brake shaft 36 and sun gear 22. Brake system 200 is released by rotating locking arm 304 against the force of spring 310 and away from detent wheel 302, to remove lock pin 306 from engagement with a notch 302a and permit the rotation of the detent wheel, and coupled brake shaft 36 and sun gear 22.

In one embodiment, brake system 300 is mechanically operated (released) by a cable 312 coupled to locking arm 304. Actuating or pulling cable 312 rotates locking arm 304 against the force of spring 310, and removes lock pin 306 from engagement with a notch 302a. In a preferred embodiment, spring 310 and cable 312 are both coupled to locking arm 304 at end 304b, opposite from pivot 308.

Detent wheel 302 is preferably formed with multiple notches 302a that are regularly spaced about the perimeter. In the embodiment of FIG. 6, the perimeter of detent wheel 302 has six notches 302a, that are formed between regularly spaced teeth 302b. As detent wheel 302 rotates, notches 302a are alternately rotated into position to receive and be engaged by lock pin 306. In a preferred embodiment, teeth 302b are asymmetrically shaped, similar to a ratchet tooth. Each tooth 302b has a leading edge 303a and a trailing edge 303b. Leading edge 303a is shorter and steeper than trailing edge 303b (i.e. has a greater angle between the face of the leading edge and a tangent to a circle defined by the perimeter of detent wheel 302), to catch and securely retain lock pin 306 in notch 302a, and prevent rotation of detent wheel 302.

When brake system 300 is released and then reset or re-actuated, lock pin 306 is urged toward re-engagement with a notch 302a. Detent wheel 302 may have rotated during manual operation of rolling shutter 10, and may not be properly oriented to align a notch 302a for engagement of lock pin 306. When the operation of motor 16 is restored, detent wheel 302 will rotate when the motor is turned on, and lock pin 306 will slide or roll over the circumference of the detent wheel until it becomes aligned with and engages a notch 302a. The longer, shallower angle of tooth trailing edge 303b facilitates the movement of lock pin 306 on the circumference of the detent wheel 302, until the lock pin engages a notch 302a to stop further rotation of the detent wheel. In one embodiment, lock pin 306 comprises a rotatable bearing 306a to facilitate the movement of lock pin 306 on the circumference of the detent wheel 302 between notches 302a.

Brake cables 118, 208, and 312 may be operated by various means known in the art, including mechanically and hydraulically. In one embodiment, brake systems 100, 200, and 300 are coupled to a manually operated mechanical switch or lever (not shown), to ensure that the brake systems can be released during a power outage. Operation (e.g., rotation) of the lever mechanically exerts or releases tension on cable 118,208, or 312 which is transmitted to lever 112, 204, or 304 to release or actuate brake system 100, 200, or 300. Cables 118, 208, and 312 permit the manual lever to be positioned remotely from brake system 100, 200, or 300 at a location convenient for a user.

Rolling shutter 10 may be configured such that drive cylinder 14 is urged to rotate and automatically raise the shutter curtain when brake 34 is released, to facilitate egress in emergency situations where motor 16 is inoperable. In one embodiment, rolling shutter 10 includes a torsion spring assembly 38 that is coupled to drive cylinder 14. Torsion spring assembly 38 is preferably positioned within drive cylinder interior space 18, at cylinder end 14b opposite motor 16 and planetary gear system 20.

In the embodiment of FIGS. 1 and 2, torsion spring assembly 38 comprises a torsion spring 40 and a spring shaft 42. Spring shaft 42 is a cylindrical tube having spring shaft ends 42a and 42b, and an interior channel 42c that extends the length of the spring shaft. Spring shaft end 42b is coupled to end cap 12b, and may be mounted on a bracket 13 that is connected to end cap 12b and is dimensioned to support the weight of drive cylinder end 14b. Bracket 13 may extend over brake 34, such that the brake is positioned between the bracket and end cap 12b, as best shown in FIGS. 4 and 5.

Spring shaft channel 42c is sized and shaped to receive brake shaft 36, which passes through and rotates freely within and independently of spring shaft 42. In one embodiment, bushings 43 are positioned in spring shaft channel 42c, and are sized and shaped to receive and rotatably suspend brake shaft 36 in the spring shaft channel. Bushings 43 are preferably positioned at spring shaft ends 42a and 42b, and may be bronze bushings that are self-lubricating for reduced rotational friction, as is known in the art.

Torsion spring 40 is a helical or coil spring that is wound about spring shaft 42, and has opposite spring ends 40a and 40b. Spring end 40a is coupled to spring shaft 42, such as at spring shaft end 42a. Spring end 42b is coupled to and rotates with drive cylinder end 14b, proximal to spring shaft end 42b and brake 34. As drive cylinder 14 is rotated to lower the shutter curtain and close an opening, the rotation of the drive cylinder twists the coupled torsion spring 40 to store mechanical energy. Twisted torsion spring 40 exerts torque to urge the rotation of drive cylinder 14 in the opposite direction to raise the shutter curtain, which is prevented by the operation of motor 16. When brake 34 is released, drive cylinder 14 is free to rotate independently of motor 16, and torsion spring assembly 38 urges drive cylinder 14 to rotate and raise the shutter curtain.

In one embodiment, torsion spring assembly 38 is configured to balance the load of the shutter curtain, and preferably exerts sufficient force to automatically raise the shutter curtain from the closed position and open the shutter curtain to a predetermined height when brake 34 is released—e.g., 36 inches, 42 inches, or a height consistent with the applicable building codes and regulations. Torsion spring 40 may be sized and/or the spring tension adjusted based on the curtain weight. In one embodiment, spring shaft end 42b is coupled to a torsion adjustment disc 44. The rotation of adjustment disc 44 rotates spring shaft 42, and twists the coupled torsion spring 40 to adjust the spring tension. Adjustment disc 44 may be positioned adjacent to brake 34, between bracket 13 and end cap 12b, as best shown in FIGS. 4 and 5. Adjustment disc 44 may be configured to receive a pin (not shown) that prevents further rotation of the adjustment disc and spring shaft 42 after adjustment of the spring tension.

Those of skill in the art will appreciate that egress systems for motorized rolling shutters are designed for limited use when the motor is not functional. Although manual (non-motorized) operation of rolling shutter 10 is possible, the egress system is not intended for the general non-motorized operation of rolling shutter 10, and is only intended for emergency use to automatically raise the shutter curtain to the predetermined height. In addition, torsion spring assembly 38 would make it difficult for a user to manually raise or lower the shutter curtain from the predetermined automatic opening height.

It will be apparent to those of skill in the art that changes and modifications may be made in the embodiments illustrated herein, without departing from the spirit and scope of the invention.

What is claimed is:

1. An egress system for a motorized rolling shutter, comprising:
a rotatable hollow cylinder having an interior space;
a planetary gear system positioned in the cylinder interior space, comprising:
a rotatable sun gear;
a rotatable planet gear in meshing engagement with the sun gear;
a rotatable carrier, the planet gear rotatably coupled to the carrier; and
a ring gear rotationally coupled to the cylinder, the planet gear in meshing engagement with the ring gear and positioned between the ring gear and sun gear;
a motor coupled to the carrier, the motor having an on state which drives the rotation of the carrier, and an off state that arrests the rotation of the carrier; and
a brake coupled to the sun gear, the brake reversibly actuated to arrest rotation of the sun gear, or released to permits rotation of the sun gear;
wherein the motor in the off state and the brake released, permits rotation of the planet gear on the arrested carrier, and allows rotation of the ring gear and the coupled cylinder.

2. The egress system of claim 1, wherein the motor is positioned in the cylinder interior space.

3. The egress system of claim 1, further comprising a torsion spring coupled to and exerting a rotational force on the sun gear.

4. The egress system of claim 1, wherein the brake is a disc brake.

5. The egress system of claim 1, wherein the brake is a drum brake.

6. The egress system of claim 1, wherein the brake is a detent brake.

7. The egress system of claim 6, wherein the detent brake comprises:
a ratchet wheel rotationally coupled to the sun gear, the ratchet wheel having a notch; and
a pawl including a lever and an end, the ratchet wheel notch sized and shaped to receive the pawl end;
wherein the brake in the actuated position has the pawl end received in the ratchet wheel notch to arrest the rotation of the ratchet wheel and coupled sun gear.

8. The egress system of claim 7, wherein the ratchet wheel has a perimeter, and the notch is positioned at the perimeter.

9. The egress system of claim 8, further comprising a spring coupled to the pawl lever, the spring urging the pawl end toward engagement with the ratchet wheel notch.

10. An egress system for a motorized rolling shutter, comprising:
a rotatable hollow cylinder having an interior space;
a planetary gear system positioned in the cylinder interior space, comprising:
a rotatable sun gear;
a rotatable planet gear in meshing engagement with the sun gear;
a rotatable carrier, the planet gear rotatably coupled to the carrier; and
a ring gear rotationally coupled to the cylinder, the planet gear in meshing engagement with the ring gear and positioned between the ring gear and sun gear;
a motor positioned in the cylinder interior space and coupled to the carrier, the motor having an on state that drives the rotation of the carrier, and an off state that arrests the rotation of the carrier;
a detent brake coupled to the sun gear, comprising:
a locking arm with a lock pin; and
a detent wheel rotationally coupled to the sun gear, the detent wheel having a notch that is sized and shaped to receive the lock pin;
wherein the detent brake is moveable between an actuated position with the lock pin received in the detent wheel notch to arrest the rotation of the detent wheel and coupled sun gear, and a released position with the lock pin removed from the detent wheel notch to permit rotation of the detent wheel and coupled sun gear; and
a torsion spring coupled to and exerting a rotational force on the cylinder;
wherein the brake in the released position permits the rotation of the planet gear on the arrested carrier, which permits rotation of the ring gear and coupled cylinder with the motor in the off state.

11. An egress system for a motorized rolling shutter, comprising:
a rotatable hollow cylinder having an interior space;
an articulated curtain coupled to the cylinder, the curtain moveable between a raised position wound about the cylinder, and a lowered position unwound from the cylinder;
a planetary gear system positioned in the cylinder interior space, comprising:
a rotatable sun gear;
a rotatable planet gear in meshing engagement with the sun gear;
a rotatable carrier, the planet gear rotatably coupled to the carrier; and
a ring gear rotationally coupled to the cylinder, the planet gear in meshing engagement with the ring gear and positioned between the ring gear and sun gear;
a motor coupled to the carrier, the motor having an on state which drives the rotation of the carrier and the movement of the curtain, and an off state that arrests the rotation of the carrier and the movement of the curtain; and
a brake coupled to the sun gear, the brake having an actuated position that arrests rotation of the sun gear, and a released position that permits rotation of the sun gear;
wherein the brake in the released position permits rotation of the planet gear on the arrested carrier, which allows rotation of the ring gear and the coupled cylinder, and allows the movement of the curtain with the motor in the off state.

12. The egress system of claim 11, further comprising a torsion spring coupled to and exerting a rotational force on the sun gear;
wherein the torsion spring urges the curtain toward a raised position with the brake in the released position.

13. The egress system of claim 11, wherein the movement of the curtain toward a lowered position moves the brake to the released position.

14. The egress system of claim 11, wherein the curtain has a fully lowered position, and further comprising:
a lock moveable between locked and unlocked positions, the locked position securing the curtain in the fully lowered position;
wherein the movement of the lock to the locked position moves the brake to the released position.
